(19) United States
(12) Patent Application Publication
(10) Pub. No.: US 2009/0279407 A1
(43) Pub. Date: Nov. 12, 2009

(54) SETUP FOR STORING DATA IN A HOLOGRAPHIC STORAGE MEDIUM

(75) Inventor: Frank Jeroen Pieter Schuurmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/294,257

(22) PCT Filed: Mar. 28, 2007
(86) PCT No.: PCT/IB07/51083

§ 371 Date: Sep. 24, 2008

(30) Foreign Application Priority Data
Mar. 29, 2006 (EP) 06300300.8

(51) Int. Cl. G11B 7/00

(52) U.S. Cl. 369/103; G9B/7

(57) ABSTRACT

The present invention relates to a setup for storing data in a holographic storage medium, comprising a spatial light modulator medium (18), a detector (20), a holographic storage medium (10), a first lens (22) between the spatial light modulator medium and the holographic storage medium, and a second lens (24) between the holographic storage medium and the detector, wherein the distance between a surface of the spatial light modulator medium and a principal plane of the first lens corresponds to the focal distance of the first lens, and the distance between the principal plane of the first lens and a reference plane through the holographic storage medium corresponds to the focal distance of the first lens, wherein the distance between the reference plane through the holographic storage medium and a principal plane of the second lens corresponds to the focal distance of the second lens, and the distance between the principal plane of the second lens and a sensitive surface of the detector corresponds to the focal distance of the second lens, wherein the holographic storage medium comprises a holographic recording layer between a first substrate layer and a second substrate layer, wherein the thickness of the first substrate layer is different from the thickness of the second substrate layer, and wherein the reference layer through the holographic storage medium is not passing the holographic recording layer, thereby the holographic recording layer being out of focus of the first and second lenses.

### FIELD OF THE INVENTION

The present invention relates to a setup for storing data in a holographic storage medium. The present invention particularly relates to data storage using a spatial light modulator (SLM).

### BACKGROUND OF THE INVENTION

In holographic data storage a two-dimensional spatial light modulator (SLM) pattern containing digital information (‘0’s and ‘1’s) is projected onto a holographic storage medium. The most common configuration is the so called 4f Fourier configuration, in which the distance between the SLM and a first lens is one focal distance f₁ of this lens, the distance from this lens to the medium is f₁, the distance from the medium to a second lens is one focal distance f₂ of this second lens, and finally the distance from this second lens to a detector array is again f₂. Typically f₁=f₂.

An illustration of such a setup is given in FIG. 2. The light from a laser is directed towards a reflective spatial light modulator 18 (R-SLM, e.g. a LCoS device) by means of a polarizing beam splitter 26. The two-dimensional data page generated by the R-SLM is reflected back towards an imaging lens 22, which focuses the light into the holographic medium 110. This light interferes in the medium with the reference beam (not shown) and results in the refractive index modulation representing the data. During read out, the medium 110 is illuminated with the reference beam, resulting, by means of diffraction, in the reconstruction of the original data page wavefront. The diffracted light is imaged with a lens 24 onto the detector array 20 (e.g. CMOS or CCD array). Note that the distance from the SLM to the first lens 22 corresponds to the focal distance of this lens 22 and is equal to the distance from the lens 22 to the medium 110, the distance from the medium 110 to the second lens 24, as well as the distance from the second lens 24 to the detector array 20; hence the name 4f configuration.

As can be seen from FIG. 2, the medium is in focus, with a spot size S roughly equal to S=(Kλ/NA)², where K² is the number of pixel in the SLM, λ is the wavelength of light, and NA=sinΘ is the numerical aperture of the lenses used. However, the intensity distribution through this focus is not homogenous, but is strongly peaked with a peak width of λ/NA and an intensity scaling with K⁴. In fact, the intensity distribution is the Fourier transform of the image on the SLM and the peak arises from the non-zero DC Fourier component. This peak does not carry any information on which of the pixels is ‘1’ and which is ‘0’, and is thus undesirable. Furthermore, the intensity of this peak (˜K⁴) is orders of magnitude larger than surrounding intensity (˜K²) and hence will burn the medium and/or introduce undesirable non-linearities in the refractive index modulation.

The most common solution of this problem is illustrated in FIG. 3, which is positioning the holographic recording layer not exactly in focus but out of focus. The optical system is now asymmetric as the material is placed eccentric. This is undesirable because of the additional wavefront aberrations that are introduced this way. In a fully symmetric design, Coma and Distortion are completely absent, hence a symmetric design is preferred.

It is therefore an object of the invention to provide a solution in order to avoid the undesired DC Fourier component without introducing additional wavefront aberrations.

### SUMMARY OF THE INVENTION

The above objects are solved by the features of the independent claims. Further developments and preferred embodiments of the invention are outlined in the dependent claims.

In accordance with the invention, there is provided a setup for storing data in a holographic storage medium, comprising

a spatial light modulator medium,

a detector,

a holographic storage medium,

a first lens between the spatial light modulator medium and the holographic storage medium, and

a second lens between the holographic storage medium and the detector,

wherein the distance between a surface of the spatial light modulator medium and a principal plane of the first lens corresponds to the focal distance of the first lens, and the distance between the principal plane of the first lens and a reference plane through the holographic storage medium corresponds to the focal distance of the first lens,

wherein the distance between the reference plane through the holographic storage medium and a principal plane of the second lens corresponds to the focal distance of the second lens, and the distance between the principal plane of the second lens and a sensitive surface of the detector corresponds to the focal distance of the second lens,

wherein the holographic storage medium comprises a holographic recording layer between a first substrate layer and a second substrate layer, wherein the thickness of the first substrate layer is different from the thickness of the second substrate layer, and wherein the reference layer through the holographic storage medium is not passing the holographic recording layer, thereby the holographic recording layer being out of focus of the first and second lenses.

If for example the holographic recording layer is shifted out of focus in the direction of the first lens near the beam splitter it is advisable to have a substrate facing this lens that is thinner than the substrate on the opposite side. Thus, the design becomes “more symmetric” as compared to the prior art asymmetric design, thereby mitigating the effects of additional wavefront aberrations. Most preferably, a completely symmetric design is achievable.

Consequently, an optical setup is provided avoiding the undesired DC Fourier component with an improved wavefront behavior as compared to prior art.

Preferably, the first substrate layer and the second substrate layer of the holographic storage medium are made of a first material having a first refractive index, the holographic recording layer of the holographic storage medium is made from a second material having a second refractive index, and the first refractive index and the second refractive index differ by less than 10%. Thereby, an optically almost homogeneous holographic storage medium is provided such that the setup which is symmetric in terms of the geometrical properties is also shifted to optical symmetry.

In this sense it is preferable that the first refractive index and the second refractive index differ by less than 5%, and even more preferable the first refractive index and the second refractive index are identical.

Particularly, a central plane having equal distances from the outer substrate surfaces of the holographic storage medium matches the reference plane through the holographic storage medium. Thus, a completely symmetric setup is provided minimizing the optical wavefront aberrations.

These and other aspects of the invention will be apparent from and elucidated with reference to the embodiments described hereinafter.

### BRIEF DESCRIPTION OF THE DRAWINGS

FIG. 1 shows a setup of a holographic data storage device according to the present invention.

FIG. 2 shows a setup of a holographic data storage device according to the prior art.

FIG. 3 shows a setup of a holographic data storage device according to the prior art.

### DESCRIPTION OF PREFERRED EMBODIMENTS

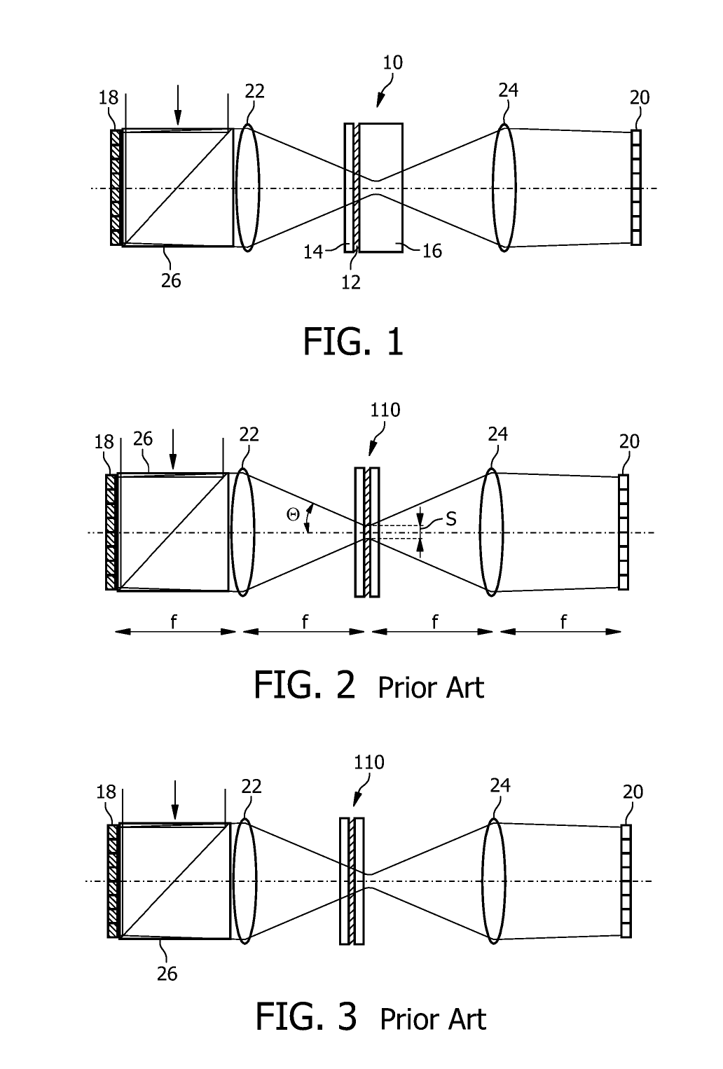

FIG. 1 shows a setup of a holographic data storage device in accordance with the present invention. The general setup is identical to the prior art setup. Therefore, reference is made to FIG. 2 and the description thereof as given above. In contrast to prior art, the holographic storage medium 10 provided has two substrates 14, 16 with different thicknesses. Thus, leaving the central plane of the whole holographic optical storage medium in focus of the setup, the holographic recording layer is shifted out of focus. Consequently, the DC Fourier component is avoided, and no additional optical wavefront aberrations are introduced.

Equivalents and modifications not described above may also be employed without departing from the scope of the invention, which is defined in the accompanying claims.

1. A setup for storing data in a holographic storage medium, comprising
a spatial light modulator medium (18),
a detector (20),
a holographic storage medium (10),
a first lens (22) between the spatial light modulator medium and the holographic storage medium, and
a second lens (24) between the holographic storage medium and the detector,
wherein the distance between a surface of the spatial light modulator medium and a principal plane of the first lens corresponds to the focal distance of the first lens, and the distance between the principal plane of the first lens and a reference plane through the holographic storage medium corresponds to the focal distance of the first lens,
wherein the distance between the reference plane through the holographic storage medium and a principal plane of the second lens corresponds to the focal distance of the second lens, and the distance between the principal plane of the second lens and a sensitive surface of the detector corresponds to the focal distance of the second lens,
wherein the holographic storage medium comprises a holographic recording layer between a first substrate layer and a second substrate layer, wherein the thickness of the first substrate layer is different from the thickness of the second substrate layer, and
wherein the reference layer through the holographic storage medium is not passing the holographic recording layer, thereby the holographic recording layer being out of focus of the first and second lenses.

2. The setup according to claim 1,
wherein the first substrate layer (12) and the second substrate layer (14) of the holographic storage medium (10) are made of a first material having a first refractive index, the holographic recording layer of the holographic storage medium is made from a second material having a second refractive index, and the first refractive index and the second refractive index differ by less than 10%.

3. The setup according to claim 2,
wherein the first refractive index and the second refractive index differ by less than 5%.

4. The setup according to claim 2,
wherein the first refractive index and the second refractive index are identical.

5. The setup according to claim 1,
wherein a central plane having equal distances from the outer substrate surfaces of the holographic storage medium matches the reference plane through the holographic storage medium.
